(19) United States
(12) Patent Application Publication
(10) Pub. No.: US 2020/0360121 A1
(43) Pub. Date: Nov. 19, 2020

(54) Dental Brushing Equipment with Attached Dental Floss Dispensing System

(71) Applicant: Mark Wise, Jacksonville Beach, FL (US)

(72) Inventor: Mark Wise, Jacksonville Beach, FL (US)

(21) Appl. No.: 16/872,742

(22) Filed: May 12, 2020

Related U.S. Application Data
(60) Provisional application No. 62/846,981, filed on May 13, 2019.

(51) Int. Cl. A61C 15/04; A46B 9/04; A46B 15/00; B65D 35/24

(52) U.S. Cl. CPC A61C 15/043; A46B 9/04; A46B 2200/1066; B65D 35/24; A46B 15/0071

(57) ABSTRACT

The disclosure relates generally to products for dental hygiene. In one embodiment, a toothbrush includes a toothbrush head with toothbrush bristles, a toothbrush handle that is connected to the toothbrush head, and a dental floss dispensing system. The dental floss dispensing system is connected to the toothbrush handle. In other embodiments, a dental floss dispensing system is connected to either a toothpaste tube body or a toothpaste cap of a toothpaste tube.

### RELATED APPLICATIONS

This application claims the benefit of provisional patent application Ser. No. 62/846,981, filed May 13, 2019, the disclosure of which is hereby incorporated herein by reference in its entirety.

### FIELD OF THE DISCLOSURE

This disclosure relates generally to the field of dental hygiene.

### BACKGROUND

Both brushing and flossing are an important part of dental hygiene. Unfortunately, dentist know that while most people brush daily, many do not use dental floss regularly. While there are currently countless brush and floss options on the market currently, none do much to change existing dental behavior. By combining the floss dispensing device with the toothpaste it now helps users correlate flossing while brushing teeth.

### SUMMARY

The disclosure relates generally to products for dental hygiene. In one embodiment, a toothbrush includes a toothbrush head with toothbrush bristles, a toothbrush handle that is connected to the toothbrush head, and a dental floss dispensing system. The dental floss dispensing system is connected to the toothbrush handle. By being connected to the toothbrush handle, a user is reminded to use the dental floss dispensing system to floss their teeth when they brush.

In another embodiment, a toothpaste tube includes a toothpaste tube body for storing toothpaste, a toothpaste cap, and a dental floss dispensing system. The toothpaste tube body defines a dispensing aperture for releasing the toothpaste from the toothpaste tube body. The toothpaste cap is configured to cover and uncover the dispensing aperture of the toothpaste tube body. To assist with flossing, a dental floss dispensing system is connected to either the toothpaste tube body or the toothpaste cap. In this manner, a user can easily brush and floss their teeth.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawings incorporated in and forming a part of this specification illustrate several aspects of the disclosure, and together with the description serve to explain the principles of the disclosure.

FIG. 1 illustrates one embodiment of a toothbrush with a dental floss dispensing system that is shown both open and closed.

FIG. 2 illustrates another embodiment of a toothbrush with a dental floss dispensing system attached and detached.

FIG. 3 illustrates an embodiment of an electric toothbrush with a dental floss dispensing system attached and detached.

FIG. 4 illustrates an embodiment of a toothpaste tube with a dental floss dispensing system that is integrated into a toothpaste cap shown in both an open position and a closed position.

FIG. 5 illustrates another embodiment of a toothpaste tube with a dental floss dispensing system that is integrated into a toothpaste cap shown in both an open position and a closed position.

FIG. 6 illustrates still another embodiment of a toothpaste tube with a dental floss dispensing system that is attached and detached to a toothpaste cap.

FIG. 7 illustrates yet another embodiment of a toothpaste tube with a dental floss dispensing system that is attached and detached to a toothpaste tube body.

FIG. 8 illustrates an embodiment of a toothpaste tube cap with a dental floss dispensing system.

FIG. 9 illustrates an embodiment of a toothpaste tube cap with a dental floss dispensing system.

FIG. 10 illustrates an embodiment of a toothpaste tube cap with a dental floss dispensing system.

FIG. 11 illustrates an embodiment of a toothpaste tube cap with a dental floss dispensing system.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

This disclosure relates generally to dental hygiene products. In particular, this disclosure relates to different combinations having either a toothbrush or the toothpaste tube with a dental floss dispensing system. The dental floss dispensing system can be combined with different types of toothbrushes and on different parts of the toothbrush and toothpaste tube. Combining the dental floss dispensing system with either the toothbrush or the toothpaste tube makes it easier for a user to both brush their teeth and floss.

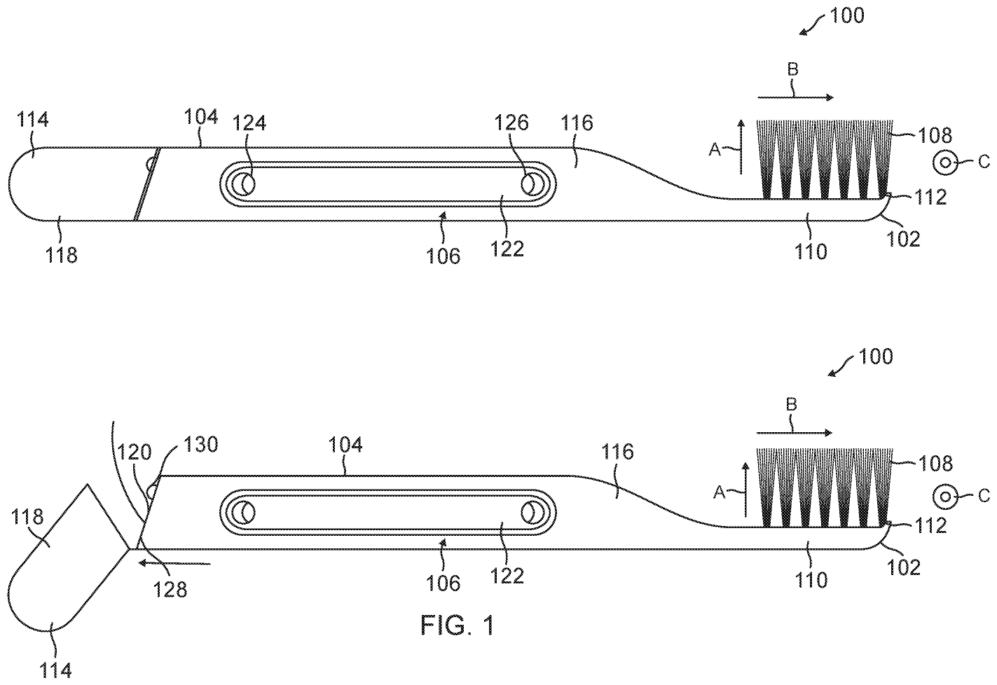

FIG. 1 illustrates one embodiment of a toothbrush 100 in accordance with this disclosure. The toothbrush 100 includes a toothbrush head 102, a toothbrush handle 104, and a dental floss dispensing system 106. The toothbrush 100 is shown in FIG. 1 with the dental floss dispensing system 106 both open and closed. The toothbrush head 102 includes toothbrush bristles 108 that are used for brushing a user's teeth.

As in shown in FIG. 1, the toothbrush bristles 108 extend out of the toothbrush head 102 transversely in a first direction A. The toothbrush head 102 has a head body 110 that may be of any suitable shape. Transverse to the direction A parallel to the length of the toothbrush handle 104 but towards the toothbrush head 102 is a direction B. When oriented in the A direction and the B direction, the C direction is transverse to both the A direction and the B direction and toward the right side of the toothbrush 100 (coming out of the page in FIG. 1).

The toothbrush handle 104 extends in the negative B direction from the head body 110 so that a user can grab the toothbrush and brush their teeth using the bristles 108 that extend in the A direction from the toothbrush head 102. The toothbrush handle 104 may be of any suitable shape and in many modern toothbrushes often takes an ergonomic shape for comfort and for ease of operation. In this embodiment, the toothbrush head 102 defines the brushing end 112 of the toothbrush 100, as is shown in FIG. 1.

The dental floss dispensing system 106 is connected to the toothbrush handle 104. In this example, the dental floss dispensing system 106 is integrated within an interior 116 of the toothbrush handle 104. An end section of the toothbrush handle 104 forms a cap 118 of the dental floss dispensing system 106, wherein the cap 118 defines the handling end 114 of the toothbrush 100. The cap 118 is swingably attached to the remainder of the toothbrush handle 104 so as to reveal a dispensing surface 120 of a fixed portion of the toothbrush handle 104 in the floss releasing state. The dental floss dispensing system 106 releases dental floss 122 from the dispensing surface 120, which is defined by the toothbrush handle 104 and revealed when the cap 118 is swung open. Generally, the cap 118 is swung closed to conceal and cover the dispensing surface 120 so that the user can use the toothbrush handle 104 to brush their teeth in the floss nonreleasing state.

The dental floss dispensing system 106 has a pair of pulleys 124, 126 that are spaced a distance P in the C direction. Each pulley 124, 126 is provided in the interior 116 so that the dental floss 122 is wrapped around the pulleys 124, 126 and the pulleys 124, 126 each have turning axes that are parallel with the C direction. A piece of the dental floss 122 extends out of the dispensing surface 120. When a user pulls on the piece of the dental floss 122 that extends out of the dispensing surface 120, the pulleys 124, 126 are turned so that more of the dental floss 122 is released from a dispensing aperture 128 defined by the dispensing surface 120. A floss cutter 130 is attached to the dispensing surface 120 so that the dental floss 122 can be cut and the cut portion of the dental floss 122 can be used by a user to floss their teeth. In one embodiment, the dental floss dispensing system 106 holds approximately 90 feet of floss. This is on average 3 to 4 months of dental floss 122 for a single person. Given that the American Dental Association recommends that toothbrushes be replaced every 3 to 4 months, a user can time when to get a new toothbrush 100 once the tooth floss 122 runs out. Having a toothbrush 100 with an integrated dental floss dispensing system 106 helps promote both brushing and flossing on a regular basis.

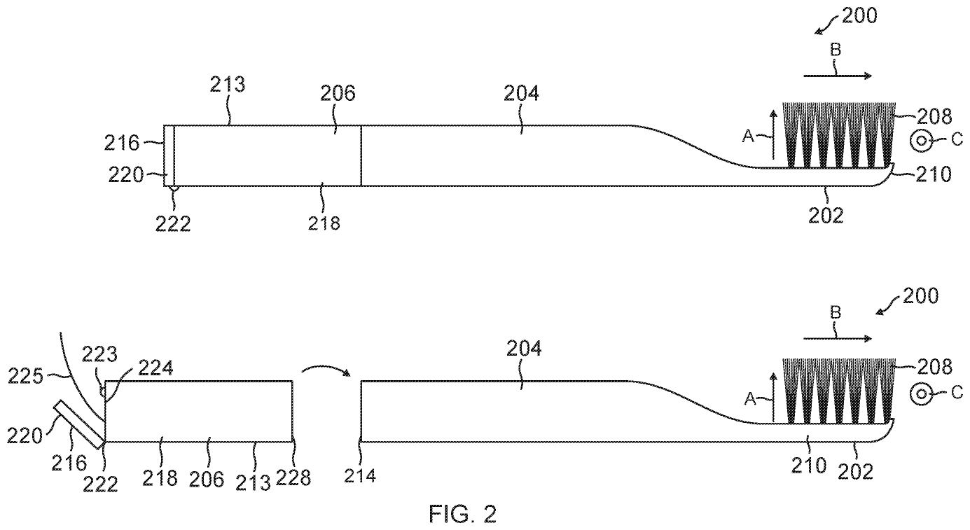

FIG. 2 illustrates one embodiment of a toothbrush 200 in accordance with this disclosure. The toothbrush 200 includes a toothbrush head 202, a toothbrush handle 204, and a dental floss dispensing system 206. FIG. 2 illustrates the toothbrush 200 with the dental floss dispensing system 206 attached and detached, as explained in further detail below. As discussed below, the dental floss dispensing system 206 is both attachable and detachable from the toothbrush 200.

As in shown in FIG. 2, the toothbrush bristles 208 extend out of the toothbrush head 202 transversely in a first direction A. The toothbrush head 202 has a head body 210 that may be of any suitable shape. Transverse to the direction A parallel to the length of the toothbrush handle 204 but towards the toothbrush head 202 is a direction B. When oriented in the A direction and the B direction, the C direction is transverse to both the A direction and the B direction and toward the right side of the toothbrush 200 (coming out of the page in FIG. 2).

The toothbrush handle 204 extends in the negative B direction from the head body 210 so that a user can grab the toothbrush and brush their teeth using the bristles 208 that extend in the A direction from the toothbrush head 202. The toothbrush handle 204 may be of any suitable shape and in many modern toothbrushes often takes an ergonomic shape for comfort and for ease of operation. In this embodiment, the toothbrush head 202 defines the brushing end 212 of the toothbrush 200, as is shown in FIG. 2.

The dental floss dispensing system 206 is connected to the toothbrush handle 204. In this example, the dental floss dispensing system 206 is detachable and forms an end section 213 of the toothbrush handle 204. When the dental floss dispensing system 206 is detached, an attachment end 214 of a fixed portion of the toothbrush handle 204 is revealed. On the other hand, when the dental floss dispensing system 206 is attached to the attachment end 214, the dental floss dispensing system 206 defines a handling end 216 of the toothbrush 200. The dental floss dispensing system 206 and thus the handling end 216 is attachable and detachable from the attachment end 214.

The dental floss dispensing system 206 defines a dispensing body 218 and a cap 220. The cap 220 is formed at the handling end 216 and is swungably attached to the dispensing body 218 by a hinge 222. Once the cap 220 is swung open, a dispensing surface 223 is revealed. The dispensing surface 223 defines a dispensing aperture 224 from where dental floss 225 in the interior (not explicitly shown) of the dispensing body 218 is dispensed. A floss cutter 226 is attached to the dispensing aperture 224 and can be used to cut a portion of the dental floss 225 that has been dispensed from the dispensing aperture 224. The cap 220 may be swung closed to cover the dispensing surface 223. This covers the dispensing surface 223 and thus protects the dental floss and the dispensing surface 223 from the exterior environment.

The dental floss dispensing system 206 may have one or more pulleys wherein the dental floss 225 wraps around the pulley(s). As the dental floss 225 is pulled from the dispensing body 218, the pulley(s) are turned and more dental floss 225 exits the dispensing body 218 though the dispensing aperture 224. However, the dental floss dispensing system 206 may be formed with any dispensing mechanism for dental floss 225. For example, motorized systems for dispensing the dental floss 225 may be provided as the dental floss dispensing system 206.

As shown in FIG. 2, the dispensing body 218 and thus the dental floss dispensing system 206 is detachable at an attachment end 214 of the toothbrush handle 204. More specifically, an attachment surface 228 is defined by the dispensing body 218 and the B direction is normal to the attachment surface 228 and the attachment end 214 when the dispensing body 218 is attached to the fixed portion of the toothbrush handle 204. The shape of the attachment end 214 and the attachment surface 228 may be the same and may depend on the cross sectional area of the toothbrush handle 204. The A and C directions may both be parallel to the attachment ends/surfaces 214, 228 when the dispensing body 218 is attached to the fixed portion of the toothbrush handle 204. By being detachable, a new dispensing system, like the dispensing system 206, may be attached and used by a user once the dental floss dispensing system 206 runs out of dental floss 225. The dispensing body 218 may be of any suitable shape and may depend on the shape of the toothbrush handle 204. Furthermore, the dispensing body 218 and the fixed portion of the toothbrush handle 204 may form a detachable connection in any suitable manner, including clips, lips and grooves, insertable members and apertures, and/or the like.

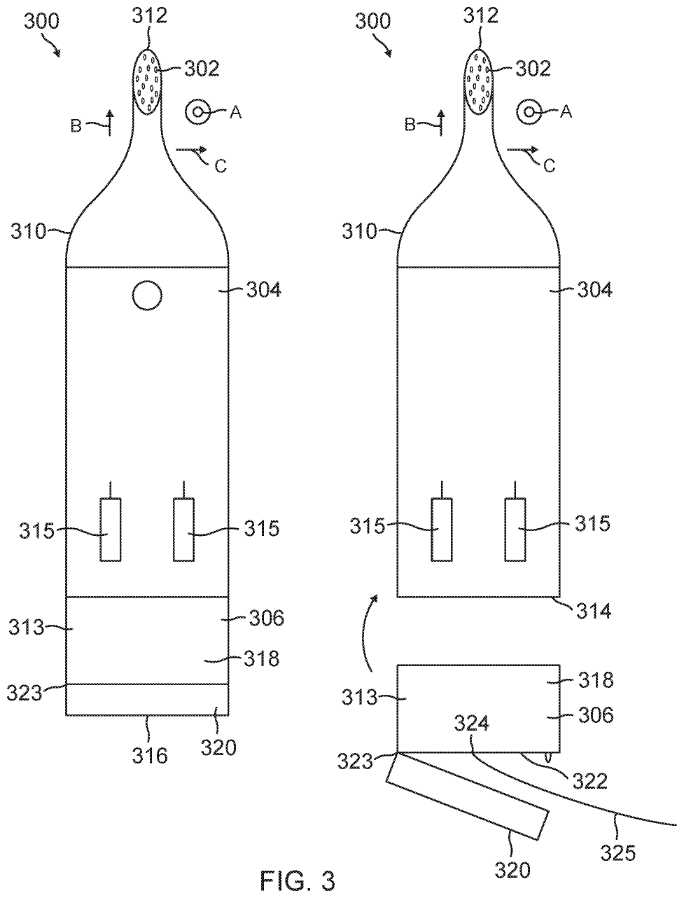

FIG. 3 illustrates one embodiment of a toothbrush 300 in accordance with this disclosure. The toothbrush 300 includes a toothbrush head 302, a toothbrush handle 304, and a dental floss dispensing system 306. FIG. 3 illustrates the toothbrush 300 also with the dental floss dispensing system 306 attached and detached, as explained in further detail below.

As in shown in FIG. 3, the toothbrush bristles 308 extend out of the toothbrush head 302 transversely in a first direction A (out of the page in FIG. 3). The toothbrush head 302 has a head body (not explicitly shown) that may be of any suitable shape. Transverse to the direction A parallel to the length of the toothbrush handle 304 but towards the toothbrush head 302 is a direction B. When oriented in the A direction and the B direction, the C direction is transverse to both the A direction and the B direction and toward the right side of the toothbrush 300.

The toothbrush handle 304 extends in the negative B direction from the head body so that a user can grab the toothbrush and brush their teeth using the bristles 308 that extend in the A direction from the toothbrush head 302. The toothbrush handle 304 may be of any suitable shape and in many modern toothbrushes often takes an ergonomic shape for comfort and for ease of operation. In this embodiment, the toothbrush head 302 defines the brushing end 312 of the toothbrush 300, as is shown in FIG. 3.

In this example, the toothbrush 300 is an electric toothbrush. Thus, the toothbrush handle 304 is shaped to store batteries 315 and to including an electric motor for turning the toothbrush head 302. Furthermore, a top portion 310 of the tooth brush handle 304 with the toothbrush head 302 are detachable from the remainder of the toothbrush handle 304 so as to be replaceable.

The dental floss dispensing system 306 is connected to the toothbrush handle 304. In this example, the dental floss dispensing system 306 is detachable and forms an end section 313 of the toothbrush handle 304. When the dental floss dispensing system 306 is detached, an attachment end 314 of a portion of the toothbrush handle 304 with the batteries 315 is revealed. On the other hand, when the dental floss dispensing system 306 is attached to the attachment end 314, the dental floss dispensing system 306 defines a handling end 316 of the toothbrush 300.

The dental floss dispensing system 306 defines a dispensing body 318 and a cap 320. The cap 320 is formed at the handling end 316 and is swungably attached to the dispensing body 318 by a hinge 323. Once the cap 320 is swung open, a dispensing surface 322 is revealed. The dispensing surface 322 defines a dispensing aperture 324 from where dental floss 325 in the interior (not explicitly shown) of the dispensing body 318 is dispensed. A floss cutter 326 is attached to the dispensing aperture 324 and can be used to cut a portion of the dental floss 325 that has been dispensed from the dispensing aperture 324. The cap 320 may be swung closed to cover the dispensing surface 322. This covers the dispensing surface 322 and thus protects the dental floss and the dispensing surface 322 from the exterior environment.

The dental floss dispensing system 306 may have one or more pulleys wherein the dental floss 325 wraps around the pulley(s). As the dental floss 325 is pulled from the dispensing body 318, the pulley(s) are turned and more dental floss 325 exits the dispensing body 318 though the dispensing aperture 324. However, the dental floss dispensing system 306 may be formed with any dispensing mechanism for dental floss 325. For example, motorized systems for dispensing the dental floss 325 may be provided as the dental floss dispensing system 306.

As shown in FIG. 3, the dispensing body 318 and thus the dental floss dispensing system 306 is detachable at the attachment surface 314 of the toothbrush handle 304. More specifically, an attachment surface 330 is defined by the dispensing body 318 and the B direction is normal to the attachment surface 314 and the attachment surface 330 when the dispensing body 318 is attached to the fixed portion of the toothbrush handle 304. The shape of the attachment surface 314 and the attachment surface 330 may be the same and may depend on the cross sectional area of the toothbrush handle 304. The A and C directions may both be parallel to the attachment surfaces 314, 330 when the dispensing body 318 is attached to the portion of the toothbrush handle 304 with the batteries 315. By being detachable, a new dispensing system, like the dispensing system 306, may be attached and used by a user once the dental floss dispensing system 306 runs out of dental floss 325. The dispensing body 318 may be of any suitable shape and may depend on the shape of the toothbrush handle 304 that stores the batteries 315. Furthermore, the dispensing body 318 and the toothbrush handle 304 may form a detachable connection in any suitable manner, including clips, lips and grooves, insertable members and apertures, and/or the like.

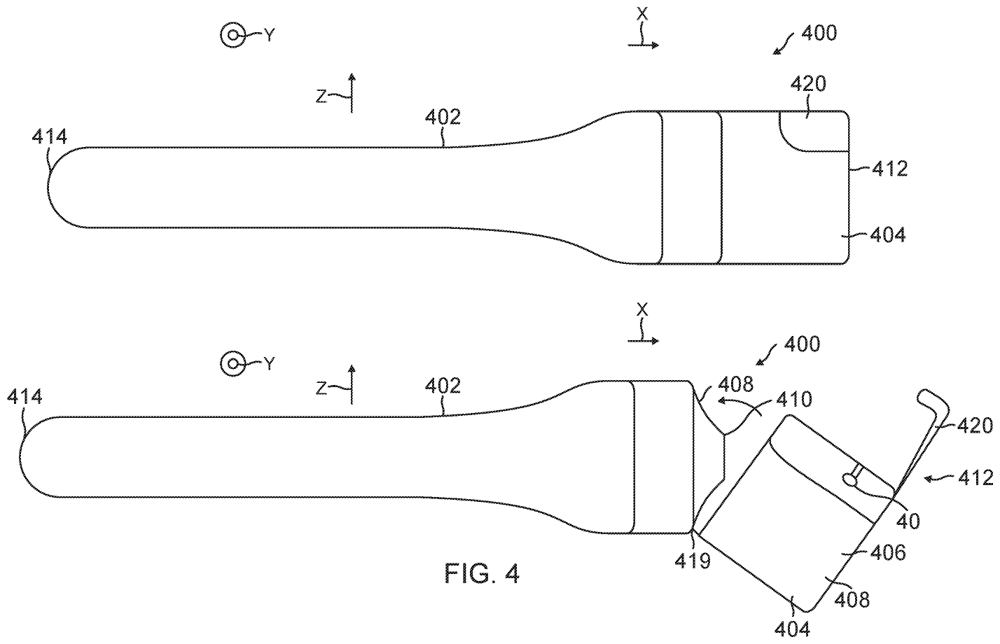

FIG. 4 illustrates one embodiment of a toothpaste tube 400 in accordance with this disclosure. The toothpaste tube 400 includes a toothpaste tube body 402 for storing toothpaste, a toothpaste cap 404, and a dental floss dispensing system 406. FIG. 4 illustrates the toothpaste tube 400 with the dental floss dispensing system 406 as closed and open so as ready to dispense dental floss 407, as explained in further detail below. Furthermore, FIG. 4 illustrates the toothpaste cap 404 opened and closed.

As shown in FIG. 4, the toothpaste tube body 402 defines a dispensing surface 408 from where toothpaste stored in the toothpaste tube body 402 is dispensed. More specifically, a toothpaste dispensing aperture 410 is defined by the dispensing surface 408 so that toothpaste exits the toothpaste tube body 402. The X direction is defined as normal to the cross sectional area of the toothpaste tube body 402. In this example, this is in general normal to the dispensing surface 408 and parallel to the direction that the toothpaste exits through the toothpaste dispensing aperture 410. The Y direction can be defined as a direction from one side of the toothpaste tube body 402 to the other side while the Z direction is transverse to both the X and the Y directions. The X, Y, and Z direction thus define a three dimensional coordinate system where the base direction is the X direction. The X direction also point towards a dispensing end 412 of the toothpaste tube 400 and opposite a closed end 414 of the toothpaste tube 400. The Y direction is selected toward the right side (coming out of the page) of the toothbrush 400 when facing toward the X direction.

The toothpaste tube body 402 extends in the negative X direction from the dispensing surface 408 so that a user can grab the toothpaste tube body 402 and squeeze the toothpaste out of the toothpaste tube body 402. The toothpaste tube body 402 may be of any suitable shape and formed from any suitable material. In this example, the toothpaste cap 404 is attached in a hinged manner to the toothpaste tube body 402. Thus, when the toothpaste cap 404 is flipped closed, the toothpaste cap 404 covers the dispensing surface 408 of the toothpaste tube body 402. When the toothpaste cap 404 is flipped open, the dispensing surface 408 is revealed so that toothpaste can be dispensed from the dispensing aperture 410.

In this example, the dental floss dispensing system 406 is connected to the toothbrush cap 404. The dental floss dispensing system 406 defines a dispensing body 418 that is connected to the toothpaste cap 404. In this example, the dispensing body 418 of the dental floss dispensing system 406 is integrated into the toothpaste cap 404. The toothpaste cap 404 is swungably attached to the dispensing body 418 by a hinge 419. The dental floss dispensing system 406 also includes a cap 420.

Once the cap 420 is swung open, a dispensing surface 421 defined by the dispensing body 418 is revealed. In this example, the dispensing surface 421 is oriented along an Z-Y plane along the top of the toothpaste cap 404. The dispensing surface 421 defines a dispensing aperture 424 from where the dental floss 407 in the interior (not explicitly shown) of the dispensing body 418 is dispensed. A floss cutter 426 is attached to the dispensing aperture 424 and can be used to cut a portion of the dental floss 407 that has been dispensed from the dispensing aperture 410. The cap 420 may be swung shut to cover the dispensing surface 421. This protects the dental floss 407 and the dispensing surface 421 from the exterior environment. The dispensing body 418 may be of any suitable shape and may depend on the shape of the toothpaste tube body 402 that stores the toothpaste.

The dental floss dispensing system 406 may have one or more pulleys wherein the dental floss 407 wraps around the pulley(s). As the dental floss 407 is pulled from the dispensing body 418, the pulley(s) are turned and more dental floss 407 exits the dispensing body 418 though the dispensing aperture 424. However, the dental floss dispensing system 406 may be formed with any dispensing mechanism for dental floss 407. For example, motorized systems for dispensing the dental floss 407 may be provided as the dental floss dispensing system 406.

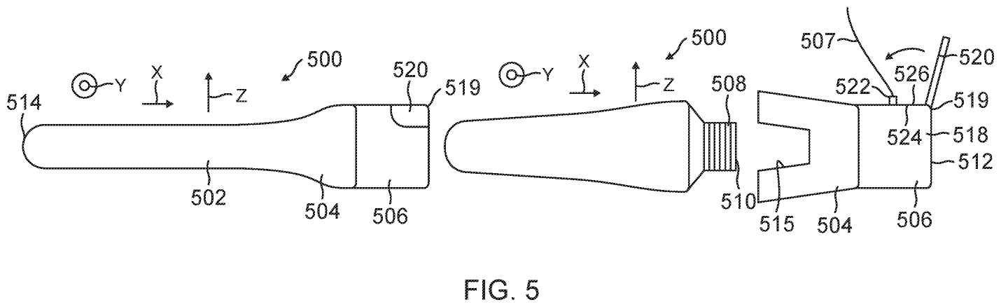

FIG. 5 illustrates one embodiment of a toothpaste tube 500 in accordance with this disclosure. The toothpaste tube 500 includes a toothpaste tube body 502 for storing toothpaste, a toothpaste cap 504, and a dental floss dispensing system 506. FIG. 5 illustrates the toothpaste tube 500 with the dental floss dispensing system 506 as closed and open so as ready to dispense dental floss 507, as explained in further detail below. Furthermore, FIG. 5 illustrates the toothpaste cap 504 opened and closed.

As shown in FIG. 5, the toothpaste tube body 502 defines a threaded tube 508 from where toothpaste stored in the toothpaste tube body 502 is dispensed. More specifically, a toothpaste dispensing aperture 510 is defined by the threaded tube 508 so that toothpaste exits the toothpaste tube body 502. The X direction is defined as normal to the cross sectional area of the toothpaste tube body 502. In this example, this is in general parallel to the axis of symmetry of the threaded tube 508 and parallel to the direction that the toothpaste exits through the toothpaste dispensing aperture 510. The Y direction can be defined as a direction from one side of the toothpaste tube body 502 to the other side while the Z direction is transverse to both the X and the Y directions. The X, Y, and Z direction thus define a three dimensional coordinate system where the base direction is the X direction. The X direction also point towards a dispensing end 512 of the toothpaste tube 500 and opposite a closed end 514 of the toothpaste tube 500. The Y direction is selected toward the right side (out of the page) of the toothbrush 500 when facing toward the X direction.

The toothpaste tube body 502 extends in the negative X direction from the threaded tube 508 so that a user can grab the toothpaste tube body 502 and squeeze the toothpaste out of the toothpaste tube body 502 though the threaded tube 508. The toothpaste tube body 502 may be of any suitable shape and any suitable material. In this example, the toothpaste cap 504 is attached in a threaded manner to the threaded tube 508 of the toothpaste tube body 502. Thus, the toothpaste cap 504 defines a threaded cavity 515 for threadably receiving the threaded tube 508 of the toothpaste tube body 502 so that the toothpaste cap 504 covers the dispensing aperture 510 of the threaded tube 508. When the toothpaste cap 504 is threadably removed from the threaded tube 508, the dispensing aperture 510 is revealed so that toothpaste can be dispensed from the dispensing aperture 510.

In this example, the dental floss dispensing system 506 is connected to the toothbrush cap 504. The dental floss dispensing system 506 defines a dispensing body 518 that is connected to the toothpaste cap 504. In this example, the dispensing body 518 of the dental floss dispensing system 506 is integrated into the toothpaste cap 504. A cap 520 is swungably attached to the dispensing body 518 by a hinge 519. Once the cap 520 is swung open, a dispensing surface 522 defined by the dispensing body is revealed. In this example, the dispensing surface 522 is oriented along a Z-Y plane along the side of the toothpaste cap 504. The dispensing surface 522 defines a dispensing aperture 524 from where the dental floss 507 in the interior (not explicitly shown) of the dispensing body 518 is dispensed. A floss cutter 526 is attached to the dispensing surface 522 and can be used to cut a portion of the dental floss 507 that has been dispensed from the dispensing aperture 524. The cap 520 may be swung closed to cover the dispensing surface 522. This covers the dispensing surface 522 and thus protects the dental floss 507 and the dispensing surface 522 from the exterior environment. The dispensing body 518 may be of any suitable shape and may depend on the shape of the toothpaste cap 504.

The dental floss dispensing system 506 may have one or more pulleys wherein the dental floss 507 wraps around the pulley(s). As the dental floss 507 is pulled from the dispensing body 518, the pulley(s) are turned and more dental floss 507 exits the dispensing body 518 though the dispensing aperture 524. However, the dental floss dispensing system 506 may be formed with any dispensing mechanism for dental floss 507. For example, motorized systems for dispensing the dental floss 507 may be provided as the dental floss dispensing system 506.

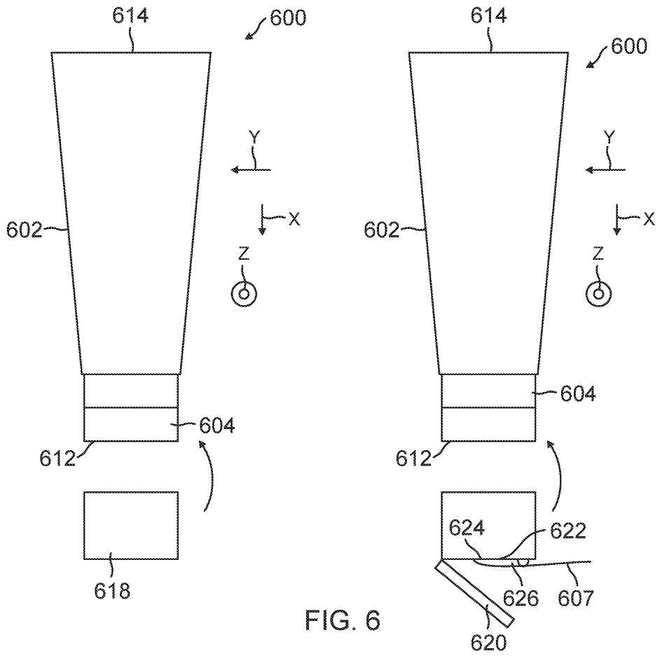

FIG. 6 illustrates one embodiment of a toothpaste tube 600 in accordance with this disclosure. The toothpaste tube 600 includes a toothpaste tube body 602 for storing toothpaste, a toothpaste cap 604, and a dental floss dispensing system 606. FIG. 6 illustrates the toothpaste tube 600 with the dental floss dispensing system 606 as closed and open so as ready to dispense dental floss 607, as explained in further detail below. FIG. 6 also shows the dental floss dispensing system 606 attached and detached to the toothpaste cap 604, as explained in further detail below.

As shown in FIG. 6, the toothpaste tube body 602 defines a dispensing surface 608 from where toothpaste stored in the toothpaste tube body 602 is dispensed. More specifically, a toothpaste dispensing aperture 610 is defined by the dispensing surface 608 so that toothpaste exits the toothpaste tube body 602. The X direction is defined as normal to the cross sectional area of the toothpaste tube body 602. In this example, this is in general normal to the dispensing surface 608 and parallel to the direction that the toothpaste exits through the toothpaste dispensing aperture 610. The Y direction can be defined as a direction from one side of the toothpaste tube body 602 to the other side while the Z direction (coming out of the page) is transverse to both the X and the Y directions. The X, Y, and Z direction thus define a three dimensional coordinate system where the base direction is the X direction. The X direction also point towards a dispensing end 612 of the toothpaste tube 600 and opposite a closed end 614 of the toothpaste tube 600. The Y direction is selected toward the right side of the toothbrush 600 when facing toward the X direction.

The toothpaste tube body 602 extends in the negative X direction from the dispensing surface so that a user can grab the toothpaste tube body 602 and squeeze the toothpaste out of the toothpaste tube body 602. The toothpaste tube body 602 may be of any suitable shape and made from any suitable material. In this example, the toothpaste cap 604 is screwed onto the toothpaste tube body 602. Thus, when the toothpaste cap 604 is closed, the toothpaste cap 604 covers the dispensing surface (not explicitly shown) of the toothpaste tube body 602. When the toothpaste cap 604 is flipped open, the dispensing surface is revealed so that toothpaste can be dispensed from the dispensing aperture (not explicitly shown).

In this example, the dental floss dispensing system 606 defines a dispensing body 618 that is connected to the top of the toothpaste cap 604. The dispensing body 618 of the dental floss dispensing system 606 is also detachable from the top of the toothpaste cap 604. In this case, the dental floss dispensing system 606 snaps onto the top of the toothpaste cap 604 with a connector or the like.

The dental floss dispensing system also includes a cap 620. Once the cap 620 is swung open, a dispensing surface 622 defined by the dispensing body 618 is revealed. In this example, the dispensing surface 622 is located on a plane parallel to the top of the toothpaste cap 604 and below the cap 620 when the cap 620 is closed. The dispensing surface 622 defines a dispensing aperture 624 from where the dental floss 607 in the interior (not explicitly shown) of the dispensing body 618 is dispensed. A floss cutter 626 is attached to the dispensing aperture 624 and can be used to cut a portion of the dental floss 607 that has been dispensed from the dispensing aperture 624. The cap 620 may be swung shut to cover the dispensing surface 622. This protects the dental floss 607 and the dispensing surface 622 from the exterior environment. The dispensing body 618 may be of any suitable shape and may depend on the shape of the toothpaste tube body 608 that stores the toothpaste.

The dental floss dispensing system 606 may have one or more pulleys wherein the dental floss 607 wraps around the pulley(s). As the dental floss 607 is pulled from the dispensing body 618, the pulley(s) are turned and more dental floss 607 exits the dispensing body 618 though the dispensing aperture 624. However, the dental floss dispensing system 606 may be formed with any dispensing mechanism for dental floss 607. For example, motorized systems for dispensing the dental floss 607 may be provided as the dental floss dispensing system 606.

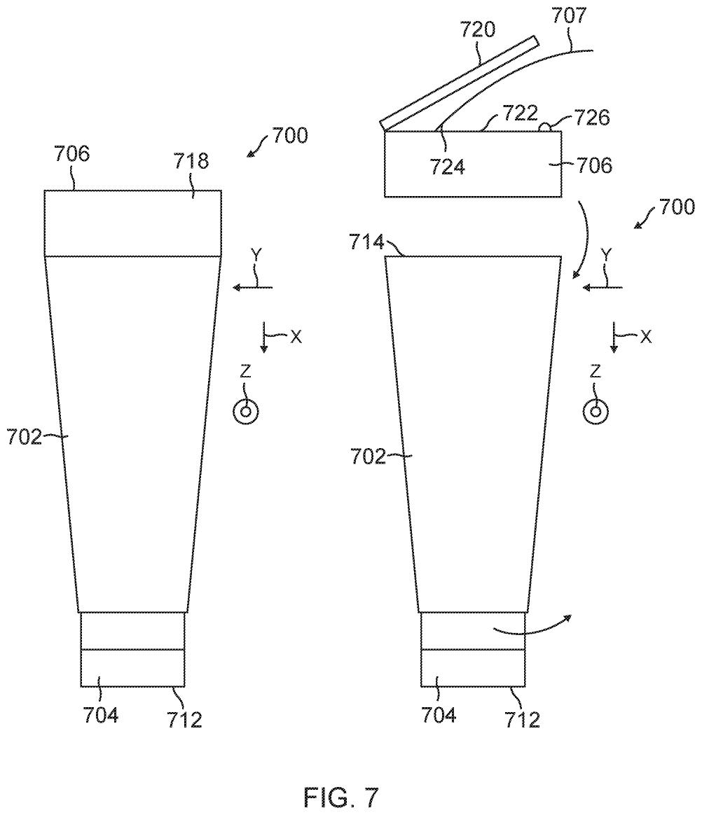

FIG. 7 illustrates one embodiment of a toothpaste tube 700 in accordance with this disclosure. The toothpaste tube 700 includes a toothpaste tube body 702 for storing toothpaste, a toothpaste cap 704, and a dental floss dispensing system 706. FIG. 7 illustrates the toothpaste tube 700 with the dental floss dispensing system 706 closed and open so as ready to dispense dental floss 707, as explained in further detail below. FIG. 7 also shows the dental floss dispensing system 706 attached and detached to the bottom of the toothpaste tube body 702, as explained in further detail below.

As demonstrated by FIG. 7, the toothpaste tube body 702 defines a dispensing surface (not explicitly shown) from where toothpaste stored in the toothpaste tube body 702 is dispensed. More specifically, a toothpaste dispensing aperture (not explicitly shown) is defined by the dispensing surface so that toothpaste exits the toothpaste tube body 702. The X direction is defined as normal to the cross sectional area of the toothpaste tube body 702. In this example, this is in general normal to the dispensing surface and parallel to the direction that the toothpaste exits through the toothpaste dispensing aperture (not explicitly shown). The Y direction can be defined as a direction from one side of the toothpaste tube body 702 to the other side while the Z direction (coming out of page) is transverse to both the X and the Y directions. The X, Y, and Z direction thus define a three dimensional coordinate system where the base direction is the X direction. The X direction also point towards a dispensing end 712 of the toothpaste tube 700 and opposite a closed end 714 of the toothpaste tube 700. The Y direction is selected toward the right side of the toothbrush 700 when facing toward the X direction.

The toothpaste tube body 702 extends in the negative X direction from the dispensing surface so that a user can grab the toothpaste tube body 702 and squeeze the toothpaste out of the toothpaste tube body 702. The toothpaste tube body 702 may be of any suitable shape and any suitable material. In this example, the toothpaste cap 704 is attached in a hinged manner to the toothpaste tube body 702. Thus, when the toothpaste cap 704 is flipped closed, the toothpaste cap 704 covers the dispensing surface (not explicitly shown) of the toothpaste tube body. When the toothpaste cap 704 is flipped open, the dispensing surface is revealed so that toothpaste can be dispensed from the dispensing aperture (not explicitly shown).

In this example, the dental floss dispensing system 706 defines a dispensing body 718 that is connected to the bottom of the toothpaste tube body 702 at the closed end 714. The dispensing body 718 of the dental floss dispensing system 706 is also detachable from the closed end 714 of the toothpaste tube body 702. In this case, the dental floss dispensing system 706 snaps onto the closed end 714 of the toothpaste tube body 702 with a connector or the like.

The dental floss dispensing system also includes a cap 720. Once the cap 720 is swung open, a dispensing surface 722 defined by the dispensing body 718 is revealed. In this example, the dispensing surface 722 is located on a plane parallel to the top of the toothpaste cap 704 and below the cap 720 when the cap is closed. The dispensing surface 722 defines a dispensing aperture 724 from where the dental floss 707 in the interior (not explicitly shown) of the dispensing body 718 is dispensed. A floss cutter 726 is attached to the dispensing surface 722 and can be used to cut a portion of the dental floss 707 that has been dispensed from the dispensing aperture 724. The cap 720 may be swung shut to cover the dispensing surface 722. This protects the dental floss 707 and the dispensing surface 722 from the exterior environment. The dispensing body 718 may be of any suitable shape and may depend on the shape of the toothpaste tube body 708 that stores the toothpaste.

Additionally, the dental floss dispensing system 706 may have one or more pulleys wherein the dental floss 707 wraps around the pulley(s). As the dental floss 707 is pulled from the dispensing body 718, the pulley(s) are turned and more dental floss 707 exits the dispensing body 718 though the dispensing aperture 724. However, the dental floss dispensing system 706 may be formed with any dispensing mechanism for dental floss 707. For example, motorized systems for dispensing the dental floss 707 may be provided as the dental floss dispensing system 706.

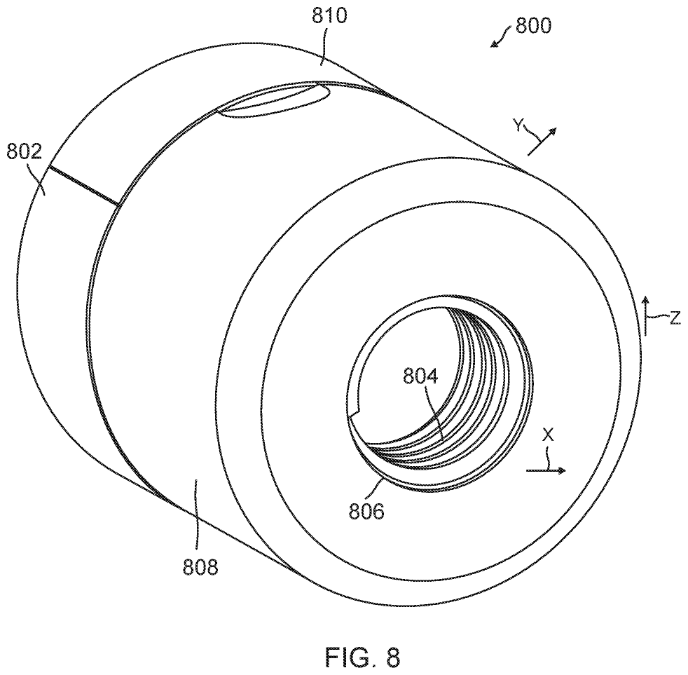

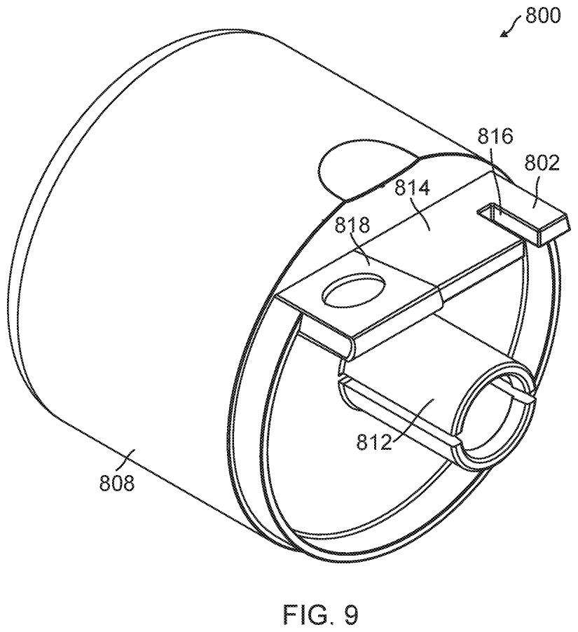

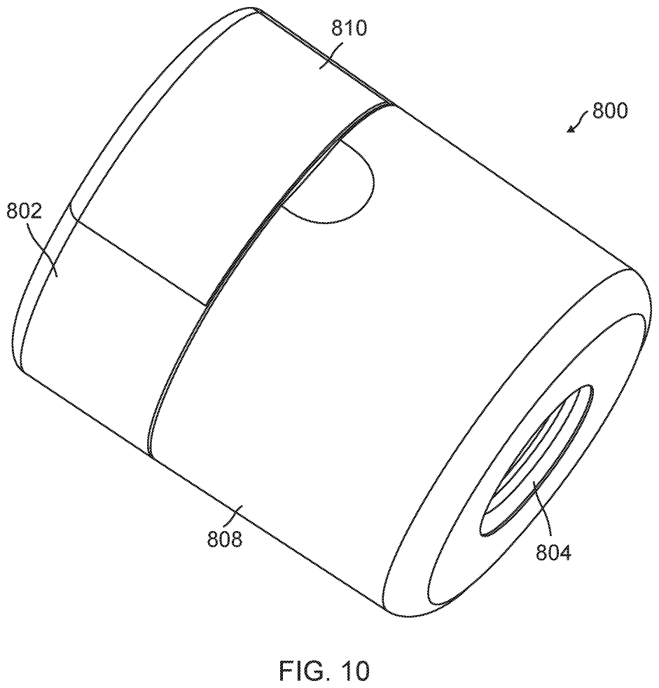

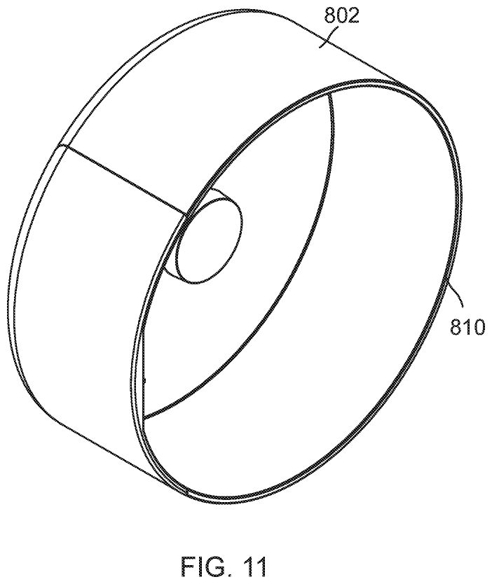

FIG. 8-FIG. 11 illustrates another embodiment of a toothpaste tube cap 800 with a dental floss dispensing system 802. The toothpaste cap 800 is attached in a threaded manner to the threaded tube 508 (See FIG. 5) of the toothpaste tube body 502 (See FIG. 5). Thus, the toothpaste cap 800 defines a threaded cavity 804 for threadably receiving the threaded tube 508 (See FIG. 5) of the toothpaste tube body 502 so that the toothpaste cap 800 covers the dispensing aperture 510 of the threaded tube 508. When the toothpaste cap 800 is threadably removed from the threaded tube 508, the dispensing aperture 510 is revealed so that toothpaste can be dispensed from the dispensing aperture 510.

In this embodiment, the toothpaste tube cap 800 defines an attachment surface 806 (along the X and Y plane) at one end of the toothpaste tube cap 800. The threaded cavity 804 is exposed at the attachment surface 806 so as to extend into the toothpaste cap 800. In this example, the dental floss dispensing system 802 is connected to the toothbrush cap 800. The dental floss dispensing system 802 defines a dispensing body 808 that is connected to the toothpaste cap 800. In this example, the dispensing body 808 of the dental floss dispensing system 802 is integrated into the toothpaste cap 800. A cover 810 is removably attached at the top of the toothpaste tube cap 800. When provided on the toothpaste tube cap 800, the cover 810 defines an end of the toothpaste tube cap 800 that is opposite the end with the attachment surface 806. The dental floss dispensing system 802 is thus oppositely disposed from the threaded cavity 804.

The dental floss dispensing system 802 includes a member 812 that extends (in the positive X-direction) parallel to the threaded tube 508 when the toothpaste tube cap 800 is attached to the toothpaste tube body 502. The member 812 may be inserted through the dental floss roller (not explicitly shown). The member 812 is configured to allow the dental floss roller to spin about the member 812. In this manner, the dental floss roller with the dental floss can spin about the member 812. A dispensing wall 814 defines a dental floss dispensing aperture 816 so that dental floss on the dental floss roller spinning about the member 812 can be dispensed through the dental floss dispensing aperture 816. A dental floss cutter 818 is attached to the dispensing wall 814 so that dental floss that has been inserted through the dental floss dispensing aperture 816 can be cut. In this embodiment, the dispensing wall 814 extends in the X-Y direction. When the cover 810 is one the toothpaste cap 800, the member 812 and the dispensing wall 814 are covered by the cover 810. The cover 810 has a removable section positioned to expose the dental floss dispensing aperture 816 and the dental floss cutter 818.

Those skilled in the art will recognize improvements and modification to the preferred embodiments of the present disclosure. All such improvements and modifications are considered within the scope of the concepts disclosed herein and the claims that follow.

What is claimed is:

1. A toothpaste tube, comprising;
a toothpaste tube body for storing toothpaste, wherein the toothpaste tube body defines a dispensing aperture for releasing the toothpaste from the toothpaste tube body;
a toothpaste cap that is configured to cover and uncover the dispensing aperture of the toothpaste tube body;
a dental floss dispensing system that is connected to either the toothpaste tube body or the toothpaste cap.

2. The toothpaste tube of claim 1, wherein the dental floss dispensing system is integrated into to the toothpaste cap, wherein the toothpaste cap is attachable and detachable from the toothpaste tube body.

3. The toothpaste tube of claim 2, wherein the toothpaste cap defines a threaded cavity for threadably receiving a threaded tube of the toothpaste tube body so that the toothpaste cap covers a dispensing aperture of the threaded tube.

4. The toothpaste tube of claim 3, wherein the dental floss dispensing system is oppositely disposed from the threaded cavity.

5. The toothpaste tube of claim 3, wherein the dental floss dispensing system comprises:
a member that extends parallel to the threaded tube when the toothpaste tube cap is attached to the toothpaste tube body, wherein the member is configured to allow a dental floss roller to spin about the member;
a dispensing wall that defines a dental floss dispensing aperture so that dental floss on the dental floss roller spinning about the member can be dispensed through the dental floss dispensing aperture.

6. The toothpaste tube of claim 5, wherein the dental floss dispensing system comprises a cover configured to cover the member and the dispensing wall.

7. The toothpaste tube of claim 6, wherein the cover has a removable section positioned to expose the dental floss dispensing aperture.

8. The toothpaste tube of claim 7, wherein the cover and the threaded aperture are oppositely disposed to one another.

9. The toothpaste tube of claim 2, wherein the toothpaste cap is attached in a hinged manner to the toothpaste tube body so that when the toothpaste cap is flipped open, a dispensing surface of the toothpaste tube body is revealed so that toothpaste can be dispensed from a dispensing aperture.

10. The toothpaste tube of claim 9, wherein the toothpaste cap is swungably attached to the toothpaste tube body by a hinge.

11. The toothpaste tube of claim 9, wherein the dental floss dispensing system also includes a cap, wherein when the cap is swung open a dispensing aperture for dental floss is revealed.

12. The toothpaste tube of claim 9, wherein the dental floss dispensing system further comprises a floss cutter is attached to the dispensing aperture.

13. The toothpaste tube of claim 1 wherein the dental floss dispensing system defines a dispensing body that is connected to the toothpaste tube body.

14. The toothpaste tube of claim 13, wherein the dispensing body is connected to a closed end of the toothpaste tube body.

15. The toothpaste tube of claim 13, wherein the dispensing body is detachable and reattachable to the toothpaste tube body.

16. A toothpaste tube, comprising;
a toothpaste tube body for storing toothpaste, wherein the toothpaste tube body defines a dispensing aperture for releasing the toothpaste from the toothpaste tube body;
a toothpaste cap that is configured to cover and uncover the dispensing aperture of the toothpaste tube body;
a dental floss dispensing system that is integrated into the toothpaste cap.

17. The toothpaste tube of claim 16, wherein the toothpaste cap is attachable and detachable from the toothpaste tube body.

18. The toothpaste tube of claim 17, wherein the toothpaste cap defines a threaded cavity for threadably receiving a threaded tube of the toothpaste tube body so that the toothpaste cap covers a dispensing aperture of the threaded tube.

19. A toothbrush, comprising;
a toothpaste head defining toothbrush bristles;
a toothbrush handle having a fixed portion and a dispensing body, wherein:
the dispensing body is attachable and detachable to the fixed portion of the toothbrush handle; and
a dental floss dispensing system is integrated into the dispensing body.

20. The toothpaste tube of claim 19, wherein the dental floss dispensing system comprises a cap that is swingably attached to the dispensing body.
